(19) United States
(12) Patent Application Publication
(10) Pub. No.: US 2011/0164690 A1
(43) Pub. Date: Jul. 7, 2011

(54) METHODS AND SYSTEMS FOR LOCATION ESTIMATION

(75) Inventors: Sridhar Ramesh, Carlsbad, CA (US); Curtis Ling, Carlsbad, CA (US)

(73) Assignee: MaxLinear, Inc., Carlsbad, CA (US)

(21) Appl. No.: 12/830,245

(22) Filed: Jul. 2, 2010

Related U.S. Application Data
(60) Provisional application No. 61/222,848, filed on Jul. 2, 2009.

(51) Int. Cl. H04B 7/26; H04L 27/00; H04B 17/00

(52) U.S. Cl. 375/259; 455/507; 455/226.1; 375/316

(57) ABSTRACT

A receiver system and method for determining the location of a device in a wireless network having a plurality of transmitters is provided. The method includes receiving a signal at the device, transforming the received signal into a time-domain signal having a characteristic, and computing a range of the device from each of the plurality of transmitters based on the characteristic. Additionally, the method includes determining the location of the device based on the computed ranges. In certain embodiments, the characteristic may be a time of arrival, time difference of arrival, or a signal strength, and the wireless network is a DTV broadcasting network.

### CROSS-REFERENCES TO RELATED APPLICATIONS

The present application claims benefit under 35 USC 119(e) of U.S. provisional application No. 61/222,848, filed Jul. 2, 2009, entitled “Methods and Systems for Location Estimation,” the content of which is incorporated herein by reference in its entirety.

### BACKGROUND OF THE INVENTION

Traditional means of location estimation using a wireless receiver and known beacons, as is implemented in a traditional GPS system, require knowledge of the position of four or more beacons and the distance of the receiver from each beacon. Three beacons may be used if an assumption about location on the earth's spherical surface is allowed.

### BRIEF SUMMARY OF THE INVENTION

The present invention provides a receiver system and method of determining the location of a device in a wireless network having a plurality of transmitters. In an embodiment, a method of determining the location of a device includes receiving a signal at the device, wherein the signal is transmitted from the plurality of transmitters. The method further includes transforming the received signal into a time-domain signal having a characteristic and computing a range of the device from each of the plurality of transmitters based on the characteristic. Additionally, the method includes determining the location of the device based on the computed ranges. In certain embodiments, the characteristic may be time of arrival or time difference of arrival.

In another embodiment, a receiver system for determining the location of a device in a wireless network having a plurality of transmitters includes a radio frequency (RF) circuit configured to receive a signal that is transmitted from the plurality of transmitters. The receiver system further includes a signal processing circuit configured to transform the received signal into a time domain signal having a characteristic. Additionally, the receiver system includes a range computing circuit configured to compute a range of the device to each of the plurality of transmitters and to determine the location of the device based on the computed ranges.

In certain embodiments, the location of the device may be determined using trilateration. The received signal may include pilot tones, and the wireless network may be a digital TV (DTV) broadcasting network having a plurality of broadcast towers. In other embodiments, the DTV broadcast towers may operate as a single frequency network (SFN). In yet other embodiments, the receiver system may perform averaging, filtering and other noise-reduction techniques on the pilot tones or training sequences to reduce the effective bandwidth of the RF receiver and thereby significantly increase its sensitivity.

Embodiments of the present invention provide, among other things, the following advantages: (i) they utilize existing synchronized television broadcasts, as is employed in DTV standards, and use DTV broadcast towers as beacons, knowledge of the absolute positions of these towers are assumed; and (ii) employ differential absolute distance from these three towers to estimate the receiver's position.

The present invention will be understood more fully from the detailed description given below and from the accompanying drawings of the preferred embodiments of the invention, which, however, should not be taken to limit the invention to the specific embodiments, but are for explanation and understanding only.

### BRIEF DESCRIPTION OF THE DRAWINGS

FIG. 1 is system block diagram of a wireless network illustrating a DTV receiver in range of three TV towers in accordance with an embodiment of the present invention.

FIG. 2 is a diagram illustrating a DTV signal received by the DTV receiver in the frequency domain (A) and transformed to the time domain (B) in accordance with an embodiment of the present invention.

FIG. 3 is a diagram illustrating loci from two transmission towers in accordance with an embodiment of the present invention.

FIG. 4 is a flowchart for determining a location of a receiver within a wireless network in accordance with an embodiment of the present invention.

FIG. 5 is a block diagram illustrating an exemplary receiver system for determining a location of a device within a wireless network in accordance with an embodiment of the present invention.

### DETAILED DESCRIPTION OF THE INVENTION

Embodiments of the present invention provide an autonomous or assisted determination of location using digital television signals such as those available via the DVB-T, DVB-H, ISDB-T, CMMB, and MediaFLO broadcast standards (collectively referred to as DTV or DTV standards), though other broadcast systems such as DAB also may accommodate the invention described here. Embodiments of the present invention use the system synchronization inherent in these standards to derive position information by determination of the difference in time-of-flight from three or more broadcast towers, taking advantage of the knowledge of the location of those towers.

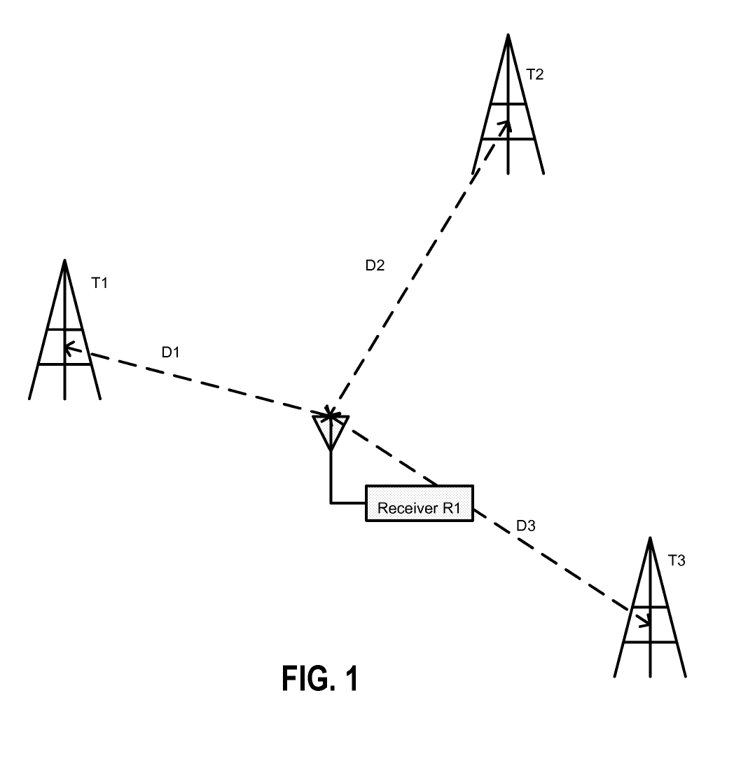

FIG. 1 is a system block diagram of a wireless network illustrating a DTV receiver R1 in range of three TV towers in accordance with an embodiment of the present invention. DTV receiver R1 receives synchronized signals from three or more DTV broadcast towers T1-T3. This synchronization is often referred to as a “single-frequency network” or SFN. SFN is a broadcast network where several transmitters simultaneously transmit the same signal over the same frequency channel. Digital broadcast networks can operate in this manner. One of the advantages of SFN is the efficient utilization of the radio spectrum, allowing a higher number of TV programs to cover a large geographic area. Systems well suited for SFN are for example terrestrial digital TV broadcasting systems DVB-T (used in Europe and many other regions outside of Europe), ISDB-T (used in Japan and Brazil), CMMT (a Chinese mobile TV and multimedia standard developed and used in China), and MediaFLO (mobile TV standard developed in the U.S.).

Receiver R1 is shown to be at a range distance D1 from DTV broadcast tower T1, at a distance D2 from tower T1, and at a distance D3 from tower T3. There exist several methods for computing the range distance of receiver R1. Once the distances of receiver R1 from towers T1-T3 are computed or measured, the location of receiver R1 can be determined. For example, the location of receiver R1 may be within the intersection portion of the three circles having centers at T1, T2, and T3 and respective radius D1, D2, and D3.

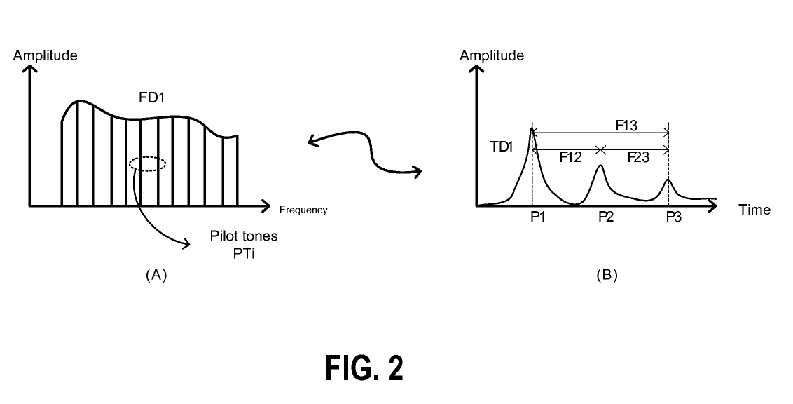

In one embodiment, the DTV receiver uses pilot tones or training sequences provided by the DTV standards to effectively demodulate the DTV signal. The SFN allows signals from each tower to be distinguished from one another. This is illustrated in FIG. 2, where the pilot tones PTi in the frequency domain FD 1 (FIG. 2A) can be used by receiver R1 to obtain a time-domain estimate of the channel impulse response TD1 (FIG. 2B) using an inverse FFT in a straightforward manner.

A byproduct of the synchronization is that the receiver R1 can determine the differential distances of each tower by providing an estimate of the time-domain channel impulse response TD1 as shown by measurements F12, F13 and F23 in FIG. 2B. That is, F12, F13, and F23 of FIG. 2B are proportional to (D1-D2), (D1-D3), and (D2-D3) of FIG. 1, respectively. Note that times P1, P2, and P3 can be measured more accurately by averaging, filtering and other filtering techniques on the pilot tones PTi or training sequences to increase the signal to noise ration (SNR). In an embodiment, the impulse response can be improved by averaging over the continuous and scattered pilot tones. In general, the SNR is a function of the range of receiver R1 from the broadcast towers, the transmit power, the antenna type, the conditions of the reception such as having line-of-sight connection with the tower, and many other factors. As shown in FIG. 2B, the peaks at P1, P2, and P3 are more distinctive with larger relative distances F12, F13, and F23, i.e., when the distance differences (D1-D2), (D1-D3), and (D2-D3) are more pronounced. In other words, the time peaks are further a part when receiver R1 is not at an equidistance to towers T1-T3. This characteristic of the time domain signal (impulse response TD1) can be useful in determining the location of receiver R1. However, receivers typically discard this information. In general, times P1, P2 and P3 are not known relative to absolute time. In an embodiment of the present invention, the time difference of arrival is used for determining the location of receiver R1.

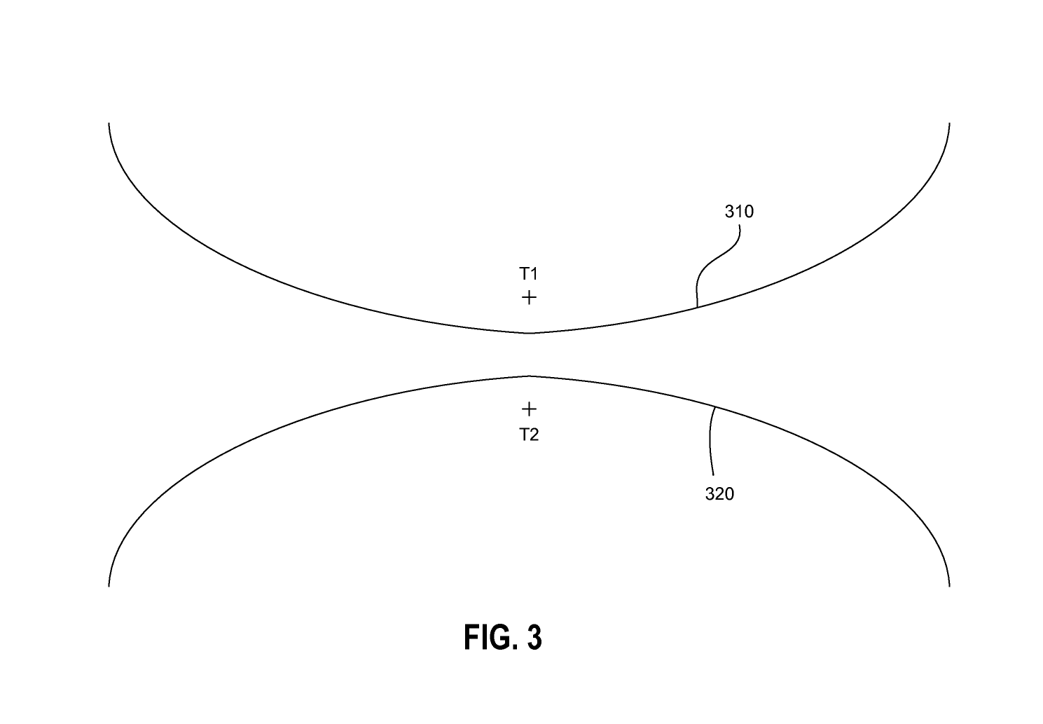

Relative distance can be used to restrict the location of the receiver R1 along hyperbolic curves. An example is provided in FIG. 3. Hyperbolic curve 310 represents the locus of the receiver R1 conditioned on the early path being from transmit tower T1, while hyperbolic curve 320 corresponds to the locus with the early path from tower T2. That is, hyperbolic curve 310 is generated from the time difference of arrival of towers T1 and T3, and hyperbolic curve 320 is generated from the time difference of arrival of towers T2 and T3.

Embodiments of the present invention collect this relative distance information and employ available trilateration techniques to estimate the position of the receiver. That is, they employ the hyperbolic curves defined by the differential distances described above, as well as the location of the earth's surface, to estimate the receiver's position. If more than three towers are available, they may be used to improve the accuracy of the position estimate as well as to calculate altitude (eliminating the need to assume location of the receiver on the earth's surface). If only two towers are available, the method provides partial information. This is refined using independent information from other sources such as conventional satellite based positioning, and is particularly useful when this independent information is unable to autonomously provide location but provides partial information. Information about the received signal power may also be used to restrict the position of the receiver to within a certain distance from either transmission tower.

The DTV receiver system may be optimized for receiving the DTV signals for the purpose of location estimation by the method described below. The receiver may perform averaging, filtering and other noise-reduction techniques on the pilot tones PTi or training sequences to reduce the effective bandwidth of the receiver and thereby significantly increase its sensitivity. In the DTV standards mentioned, this involves averaging over the continuous and scattered pilot tones to sense broadcast towers that are much further than conventional TV reception ranges.

In a CMMB, the beacon signals present at the beginning of each frame consist of two consecutive known symbols which can be used to obtain very long-distance, accurate estimates of differential distance among towers. Furthermore the receiver may switch frequencies and receive other DTV channels to obtain relative distance information at other frequencies to improve the estimation of relative distance. This has the benefit of autonomous positioning without assistance from other sources.

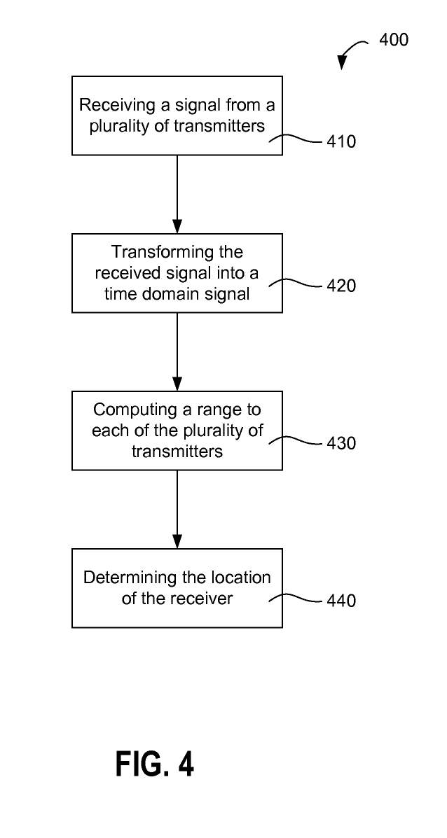

FIG. 4 is a flowchart of a process 400 for determining a location of a receiver within a wireless network having a plurality of DTV broadcast towers. Process 400 begins with receiving a signal at the receiver (step 410). At step 420, the received signal is transformed into a time-domain signal that is generally the channel impulse response characterized by one or more amplitude peaks. Each of the peaks represents a relative time of arrival of the received signal from one of the plurality of towers. The one or more peaks may have equal amplitude that represents the received signal strength, or the peaks may have different amplitudes meaning that the receiver may be located at unequal distances from the towers or one or more of the towers are not in line-of-sight communication with the receiver. The relative time distances between the peaks may be proportional to the distances of the receiver from the towers. At step 430, process 400 computes a range of the receiver from the plurality of towers based on a characteristic of the time domain signal. For example, the characteristic can be a time of arrival of the signal, a time difference of arrival, a relative signal strength, and others. At step 440, process 400 determines the location of the received based on the computed ranges. In an embodiment, the determination of the location may use a trilateration approach.

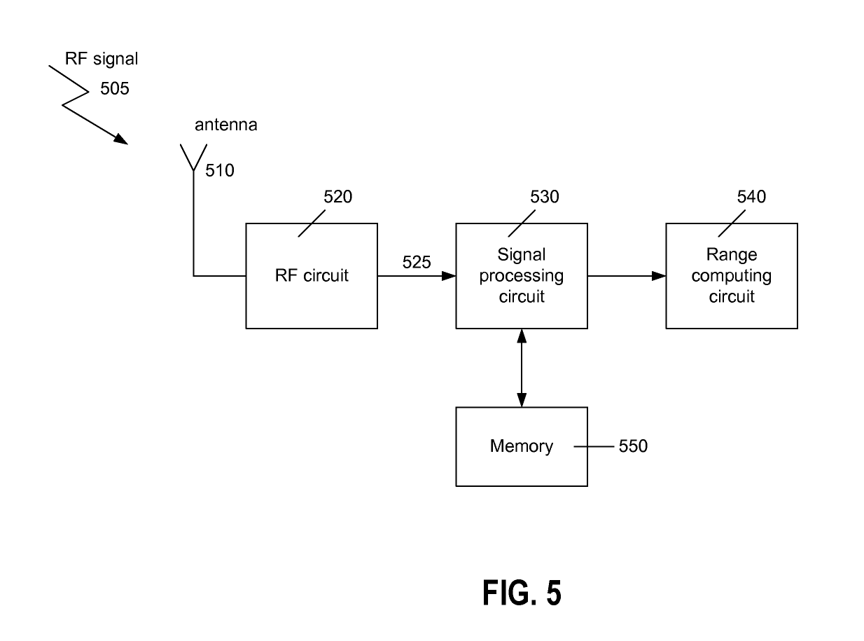

FIG. 5 is a block diagram illustrating an exemplary receiver system 500 for determining a location of a device within a wireless network in accordance with an embodiment of the present invention. Many modifications and alternatives exit, as will be clear to those skilled in the art. In the illustrated embodiment, receiver system 500 includes an antenna 510, an RF circuit 520, a signal processing circuit 530, a range computing circuit 540, and a memory circuit 550. In one embodiment of the receiver system 500, RF circuit 520 receives an RF signal 505 transmitted by a plurality of transmitters, e.g., DTV broadcast towers (shown in FIG. 1), over the air through antenna 510. Although antenna 510 is shown as a single antenna, it may comprise one or more antennas for better sensitivity through diversity. The signal 505 may includes pilot tones or training sequences. RF circuit 520 may include a low noise amplifier, a mixer, filters, and/or analog-digital converters to provide a digital baseband signal 525 to signal processing circuit 530. Signal processing circuit 530 is coupled to memory circuit 550 that is typically semiconductor-based memory such as DRAM, SRAM, SDRAM, etc. Memory circuit 550 may be used to store one or more pilot tones or training sequences from past baseband signals to enable the signal processing circuit 530 to perform averaging of pilot tones, thereby increase the sensitivity of receiver system 500. In certain embodiments, receiver system 500 may be integrated in a single semiconductor chip.

Signal processing circuit 530 may include a Fast Fourier Transform (FFT) module that transforms a frequency domain baseband signal into a time domain signal by performing an inverse FFT operation. As signal 505 is transmitted by a plurality of broadcast towers that are located at different distances from the receiver system 500, the time domain signal or the channel impulse response will have multiple peaks that may have equal or different magnitudes. An exemplary channel impulse response is shown in FIG. 2B for a signal 505 sent by broadcast towers T1, T2, and T3 (shown in FIG. 1). In the example shown, tower T1 may be located closest to receiver system 500, this fact is reflected by a characteristic expressed as time P1 while Tower T3 may be located farthest from receiver system 500, expressed as time P3 in FIG. 2B. In the exemplary embodiment, times P1, P2, and P4 are the time of arrival of the signal 505 coming from respective broadcast towers T1, T2, and T3 located at respective distances D1, D2, and D3 from the receiver system 500 as shown in FIG. 1. Times P1, P2 and P3 are generally not known to absolute time. Thus, time difference of arrivals will be used to determine the location of the receiver system 500. Range computing circuit 540 computes relative distances based on the time difference of arrival. The computed relative distances can be used to restrict the location of the receiver system 500 along hyperbolic curves as shown in FIG. 3. That is, the range computing circuit 540 can employ the hyperbolic curves defined by the differential distances, as well as the location of the earth's surface, to determine the location of the receiver system.

In another embodiment of the present invention, the characteristic may be expressed as the magnitude peak in the time domain signal. The magnitude or received signal strength may be used as information to supplement the time difference of arrival described above. In yet another embodiment, the signal strength difference may be used to compute relative distance by the range computing circuit 540 and the relative distance can be used to restrict the location of the receiver system 500 along hyperbolic curves.

In an embodiment, if more than three towers are available, they may be used to improve the accuracy of the location as well as to calculate altitude (eliminating the need to assume location of the receiver system on the earth's surface). If only two towers are available, the receiver system 500 may use independent information from other sources such as conventional satellite based positioning or any other radio frequency channels to determine its location. In some embodiments, the received signal power (signal strength) may also be used to restrict the position of the receiver system to within a certain distance from either broadcast tower.

As described above, embodiments of the present invention employ an estimated channel combined with a synchronous (SFN) network of transmitters to estimate differential distances between the receiver and a multiplicity of broadcast towers. Widely-deployed DTV standards offer such synchronous broadcast networks, but other technologies such as DAB radio may also deploy single-frequency broadcast networks and hence benefit from the present invention.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims along with their full scope of equivalents.

What is claimed is:

1. A method for determining a location of a device in a wireless network having a plurality of transmitters, the method comprising:
receiving a signal at the device;
transforming the received signal into a time-based signal having a characteristic;
computing a range of the device to each of the plurality of transmitters based on the characteristic; and
determining the location of the device based on the computed ranges.

2. The method of claim 1, wherein the wireless network is a digital TV (DTV) broadcasting network.

3. The method of claim 2, wherein the DTV broadcasting network is a single frequency network.

4. The method of claim 1, wherein the received signal comprises pilot tones.

5. The method of claim 1, wherein the characteristic is a time of arrival.

6. The method of claim 1, wherein the characteristic is a time difference of arrival.

7. The method of claim 1, wherein the transforming the received signal comprises an inverse Fast Fourier Transform (FFT) operation.

8. The method of claim 1, wherein the time-domain signal is a channel impulse response.

9. The method of claim 1, wherein the determining the location comprises trilateration.

10. The method of claim 1, wherein the plurality of transmitters comprise DTV broadcast towers.

11. A receiver system for determining a location of a device in a wireless network having a plurality of transmitters, the apparatus comprising:
a radio frequency (RF) receiving circuit configured to receive a signal;
a signal processing circuit configured to transform the received signal into a time domain signal having a characteristic;
a range computing circuit configured to compute a range of the device to each of the plurality of transmitters and to determine the location of the device based on the computed ranges.

12. The receiver system of claim 11, wherein the RF receiving circuit is coupled to one or more antennas.

13. The receiver system of claim 11, wherein the wireless network is a digital TV (DTV) broadcasting network.

14. The receiver system of claim 11, wherein the received signal comprises pilot tones.

15. The receiver system of claim 11, wherein the signal processing circuit comprises an inverse Fast Fourier Transform (FFT) operator.

16. The receiver system of claim 11, wherein the time domain signal is a channel impulse response.

17. The receiver system of claim 11, wherein the characteristic is a time of arrival.

18. The receiver system of claim 11, wherein the characteristic is a time difference of arrival.

19. The receiver system of claim 11, wherein the determining the location comprises trilateration.

20. The receiver system of claim 11, wherein the plurality of transmitters comprise DTV broadcast towers.
